(19) United States
(12) Patent Application Publication
(10) Pub. No.: US 2013/0101161 A1
(43) Pub. Date: Apr. 25, 2013

(54) METHOD AND DEVICE FOR DISTINGUISHING A SELF-LUMINOUS OBJECT FROM A REFLECTING OBJECT

(71) Applicant: Petko FABER, Renningen (DE)

(72) Inventor: Petko FABER, Renningen (DE)

(21) Appl. No.: 13/591,825

(22) Filed: Aug. 22, 2012

(30) Foreign Application Priority Data
Aug. 23, 2011 (DE) 10 2011 081 398.5

(51) Int. Cl. G01J 1/18

(52) U.S. Cl. CPC G01J 1/18
USPC 382/103

(57) ABSTRACT

A method and device for distinguishing a self-luminous object from a reflecting object in a detection range of a camera of a vehicle having at least one headlight, when the object is illuminated by the headlight, are described. The method includes a step of receiving a relative position of the object with respect to the vehicle and a brightness value of the object from the camera. Furthermore, the method includes a step of comparing the brightness value to a self-luminous value expected at the relative position and a reflection value expected at the relative position. Moreover, the method includes a step of classifying the object as self-luminous, if the brightness value is within a self-luminous tolerance range about the self-luminous value or as reflecting, if the brightness value is within a reflection tolerance range about the reflection value.

### CROSS REFERENCE TO RELATED APPLICATION

The present application claims priority to Application No. DE 10 2011 081 398.5, filed in the Federal Republic of Germany on Aug. 23, 2011, which is expressly incorporated herein in its entirety by reference thereto.

### FIELD OF INVENTION

The present invention relates to a method for distinguishing a self-luminous object from a reflecting object in a detection range of a camera of a vehicle having at least one headlight, a device for distinguishing a self-luminous object from a reflecting object in a detection range of a camera of a vehicle having at least one headlight as well as a corresponding computer program product.

### BACKGROUND INFORMATION

At night, a camera of a vehicle detects almost exclusively self-luminous objects and reflecting objects. The headlights of the vehicle brighten up a part of the ground ahead of the vehicle, which is also taken as a reflecting plane. In order to separate points of light in an image of the camera into images of reflecting objects, such as the reflectors of road guide poles and images of self-luminous objects, such as vehicle headlights, various distinguishing features may be drawn upon.

German Application No. DE 10 2008 025 749 A1, for example, describes a method and a device for classifying an object detected in at least one image of the region in front of a vehicle. A processing unit processes image data of the image taken by an image recording unit. The processing unit takes into account the light distribution of the light radiated by the at least one front headlight of the vehicle when classifying the object.

### SUMMARY

With this as background, the present invention provides an improved method for distinguishing a self-luminous object from a reflecting object in a detection range of a camera of a vehicle having at least one headlight, an improved device for distinguishing a self-luminous object from a reflecting object in a detection range of a camera of a vehicle having at least one headlight, as well as a corresponding improved computer program product according to the present invention. Advantageous refinements are described in the following description.

The present invention utilizes the fact that the illumination intensity, that is caused by a light source on an area, decreases as the square of the distance of the area from the light source. In the case of a light source having a nondirectional radiation characteristic, the illumination intensity decreases uniformly all around. In the case of a directional light source, such as a vehicle headlight, the radiated light forms a light cone which causes a light distribution, for instance, on the ground in front of the headlight. The light distribution represents the illumination intensity at various locations on the area.

A reflecting object in the light cone is illuminated using a certain illumination intensity which corresponds to a position of the reflecting object within the light distribution. With that, the reflecting object itself becomes an additional light source, whose illumination intensity of the light radiated from it, in turn, decreases as the square of the distance from the reflecting object. A receiver near the headlight is therefore able to receive only a light intensity which is lower by approximately the fourth power of the distance between headlight and reflecting object than the light flow emitted in the direction of the reflecting object by the headlight. This effect is still more reinforced by the reflectivity of the reflecting object as a function of the angle of incidence of the light onto the reflecting object.

A self-luminous object, on the other hand, has an illumination intensity which decreases only by the square of the distance from the self-luminous object.

The present invention is based upon the knowledge that, while using a known light distribution in front of a headlight, an achievable brightness value of a reflecting object is specified for various positions of the light distribution, just as an achievable brightness value of a self-luminous object is specified for the various positions of the light distribution. A comparison of the two achievable brightness values at one of the positions to an ascertained brightness value of an unknown object at the position enables a certain classification of the object.

The present invention relates to a method for distinguishing a self-luminous object from a reflecting object in a detection range of a camera of a vehicle having at least one headlight, when the object is illuminated by the headlight, the method having the following steps:
receiving a relative position of the object with respect to the vehicle and a brightness value of the object by the camera;
comparing the brightness value to a self-luminous value expected at the relative position and/or a reflection value expected at the relative position; and
classifying the object as self-luminous, if the brightness value is within a self-luminous tolerance range about the self-luminous value or as reflecting, if the brightness value is within a reflection tolerance range about the reflection value.

Furthermore, the present invention relates to a device for distinguishing a self-luminous object from a reflecting object in a detection range of a camera of a vehicle having at least one headlight, when the object is illuminated by the headlight, the device having the following features:
a device for receiving a relative position of the object with respect to the vehicle and for receiving a brightness value of the object by the camera;
a device for comparing the brightness value to a self-luminous value expected at the relative position and/or a reflection value expected at the relative position; and
a device for classifying the object as self-luminous, if the brightness value is within a self-luminous tolerance range about the self-luminous value or as reflecting, if the brightness value is within a reflection tolerance range about the reflection value. By this exemplary variant of the present invention in the form of a device, the object on which the present invention is based may also be attained quickly and efficiently.

By a self-luminous object, one may understand a light source having its own energy supply. A self-luminous object may be a headlight of a nonhost vehicle or a roadlamp or luminous advertizing. By reflecting object one may understand an object which reflects at least a portion of incident light back to its source. The reflecting object may be a roadway marking, for example, a traffic sign or a reflector of a road guide pole. A relative position may be a coordinate of the object in the image information of a camera. Since the camera is fixed to the vehicle, the image information shows a detection range of the camera that is aligned to the vehicle at a fixed angle. The light distribution of the headlight or of several headlights, such as upper beam or lower beam, has in each case a fixed illumination intensity in the camera image, in predetermined areas. As a function of the relative position with respect to the vehicle, and an alignment with respect to the vehicle, a reflecting object in the areas of light distribution has an expected value of brightness, i.e., an expected reflection value. Similarly, a self-luminous object has an expected value of brightness, i.e., an expected self-luminosity value as a function of the relative position with respect to the vehicle and an alignment of the self-luminous object to the vehicle. The values are different from one another at each common relative position with respect to the vehicle. A tolerance range may represent a fluctuation range, based, for example, on different environmental conditions.

In the case at hand, by a device, one may understand an electrical device which processes sensor signals and outputs control signals as a function thereof. The device may have an interface, which may be developed as hardware and/or software. In a hardware design, the interfaces may, for example, be part of a so-called system ASIC that contains the most varied functions of the device. However, it is also possible for the interfaces to be separate, integrated switching circuits or to be at least partially made up of discrete components. In a software design, the interfaces may be software modules which are present on a microcontroller in addition to other software modules, for example.

Furthermore, the method may have a further step of ascertaining, in which a function of self-luminosity values to be expected at different relative positions in front of the vehicle and/or a function of reflection values to be expected at different relative positions in front of the vehicle are ascertained. The step of ascertaining may be carried out directly on the vehicle, for instance, as a type of calibration. The step of ascertaining may also be carried out in a laboratory, and the self-luminosity values to be expected and/or the reflection values to be expected may be used as a data set in many vehicles having uniform vehicle illumination. Based on the ascertaining, greater accuracy may be obtained than by simulation.

In the step of receiving, in response to the moving of the vehicle, an additional relative position of the object with respect to the vehicle, and an additional brightness value of the object may be received, and in the step of comparing, an additional brightness value may be compared to an additional self-luminosity value to be expected at the additional relative position and/or to an additional reflection value to be expected at the additional relative position, and in the step of classifying, the object may also be classified as self-luminous if the additional brightness value is located within an additional self-luminous tolerance range about the additional self-luminous value or the object may be classified as reflecting if the additional brightness value is located within an additional reflection tolerance range about the additional reflection value. Because of a second brightness value of the same object at a second time, after the vehicle has moved, one is able to distinguish with greater certainty between a reflecting object and a self-illuminating object.

Furthermore, in the step of comparing, a gradient between the brightness value and the additional brightness value may be compared to a self-luminous gradient to be expected between the relative position and the additional relative position and/or a reflection gradient to be expected between the relative position and the additional relative position, and in the step of classifying, the object may further be classified as self-luminous if the gradient is located within a self-luminous gradient tolerance range about the self-luminous gradient, or the object may be classified as reflecting if the gradient is located within a reflection gradient tolerance range about the reflection gradient. By an observation of a gradient between two measured values, a section of an expectation curve may be found that has the same gradient. The relative position of the object with respect to the vehicle may be confirmed by a gradient comparison.

Moreover, the step of classifying cannot be carried out if, in the step of comparing, it is detected that the brightness value is lower than a predetermined threshold value. A threshold value is able to decrease a calculating effort for detection in that, for example, no natural environmental light is taken into account.

A computer program product is also of advantage, having program code that may be stored on a machine-readable carrier such as a semiconductor memory, a hard-disk memory or an optical memory, which is used to implement the method according to one of the exemplary embodiments described above, when the program is run on a computer or a device.

The present invention will be explained in greater detail below with reference to the accompanying drawings.

### BRIEF DESCRIPTION OF THE DRAWINGS

FIG. 1 illustrates a representation of a vehicle having a device for distinguishing a self-luminous object from a reflecting object, according to an exemplary embodiment of the present invention.

FIG. 2 illustrates a flow chart of a method for distinguishing a self-luminous object from a reflecting object, according to an exemplary embodiment of the present invention.

FIG. 3 illustrates an image of a brightness distribution from an angle of view of the camera in FIG. 1.

FIG. 4 illustrates a top view of the brightness distribution according to FIG. 3.

FIG. 5 illustrates a diagram of three characteristics curves of the brightness values to be expected, according to an exemplary embodiment of the present invention.

### DETAILED DESCRIPTION

In the subsequent description of preferred exemplary embodiments of the present invention, the same or similar reference numerals are used for the various elements shown in the various figures and acting similarly, repeated description of these elements then being omitted.

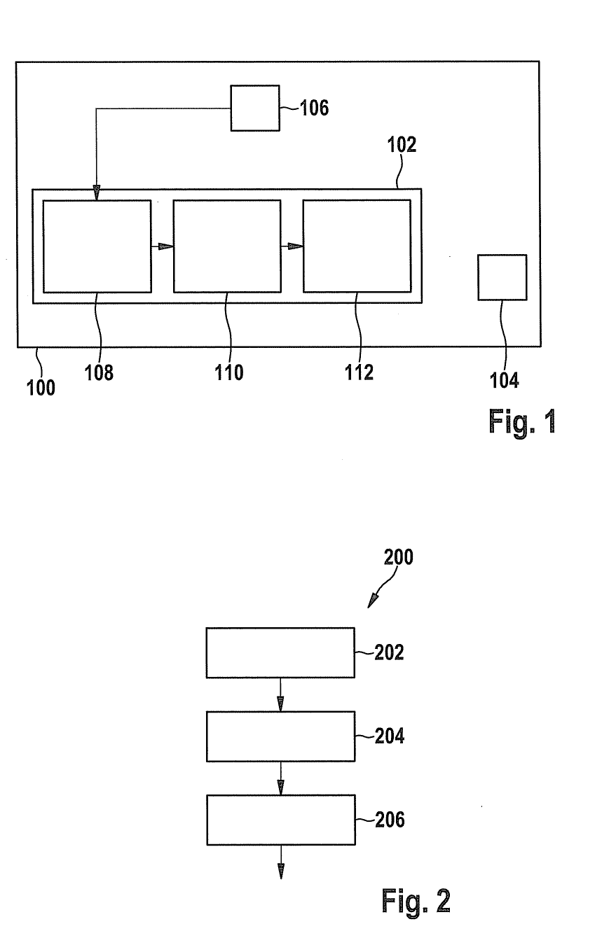

FIG. 1 shows a representation of a vehicle 100 having a device 102 for distinguishing a self-luminous object from a reflecting object, according to an exemplary embodiment of the present invention. Vehicle 100 has at least one headlight 104 and a camera 106. Device 102 has an apparatus for receiving 108, an apparatus for comparing 110 as well as an apparatus for classifying 112. Camera 106 is developed to provide an image of a detection range of the camera 106, the object being illuminated by headlight 104. The apparatus for receiving 108 is developed to receive a relative position of the object with respect to vehicle 100 and a brightness value of the object from the camera. The apparatus for comparing 110 is developed for comparing the brightness value to a self-luminous value to be expected at the received relative position and a reflection value to be expected at the received relative position. The apparatus for classifying 112 of the object is developed to classify the object as self-luminous, if the brightness value is within a self-luminous tolerance range about the self-luminous value or as reflecting, if the brightness value is within a reflection tolerance range about the reflection value.

FIG. 2 shows a flow chart of a method 200 for distinguishing a self-luminous object from a reflecting object, according to an exemplary embodiment of the present invention. The method 200 is able to be carried out as shown in FIG. 1. The method for distinguishing a self-luminous object from a reflecting object, in the detection range of a camera of a vehicle having at least one headlight, has a step of receiving 202, a step of comparing 204 and a step of classifying 206. The at least one headlight is activated and emits light in the direction of the object. In the step of receiving 202, a relative position of the object with respect to vehicle and a brightness value of the object are received by the camera. In the step of comparing 204, the brightness value is compared to a self-luminous value expected at the relative position and/or a reflection value expected at the relative position. In the step of classifying 206, the object is classified as self-luminous, if the brightness value is within a self-luminous tolerance range about the self-luminous value or is classified as reflecting, if the brightness value is within a reflection tolerance range about the reflection value.

The design approach provided in this instance refers to taking into account the active or passive change of the light distribution of the light radiated by at least one headlight of a vehicle. The information on the change may be used advantageously, for example, for distinguishing between self-luminous and reflecting objects.

Taking into consideration the light distribution in the static case or without changing the light distribution by a characteristic motion of the vehicle or the headlight does not permit any valid distinction between illuminated and reflecting objects and self-luminous objects. Only by using the information on the active and passive change in the light distribution is this feature for the differentiation able to be used meaningfully.

A conceptualized knowledge of the current light distribution as well as, under certain circumstances, its situation-dependent change (e.g., highway light, superhighway light, crossing light or dynamic cornering light) is assumed. That is, it is assumed that it is known in which areas of the image taken, objects are potentially able to be illuminated actively using the light of the host car's own headlight, and above all, how strong and distinct this illumination is. Furthermore, it is assumed that a defined or derivable change of object features as a function of the active illumination of the objects (reflecting, not self-luminous objects) is detectable, i.e., the change of, for instance, the brightness is predictable based on the active or passive change of the light distribution within tolerances. Moreover, it is assumed that, in the case of self-luminous objects, the relative constancy or specified (under certain circumstances also cyclical) change of object features, such as the detectable brightness of an object, or the spectral composition of the detectable light, is not predictable with the aid of the change in the light distribution. For a distinction between self-luminous and reflecting objects, exactly this difference, that is, the predictability of changes to be expected (the dynamics of the scene) is utilized in order to achieve a valid differentiation between self-luminous and reflecting objects.

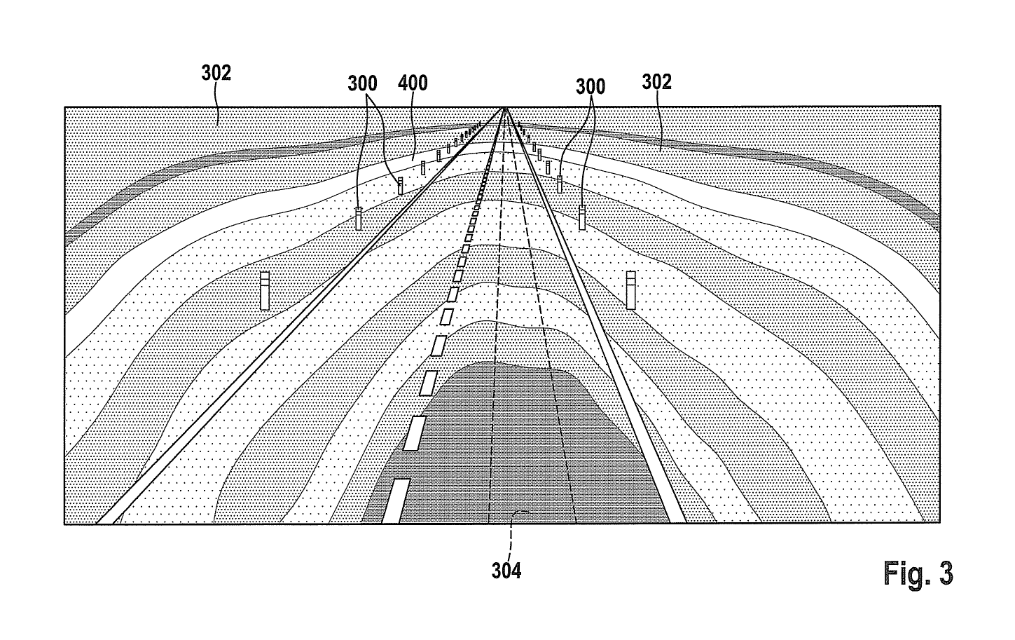

FIG. 3 shows an image of a brightness distribution from an angle of view of the camera in FIG. 1. A road extends in front of the vehicle having white lateral limitation lines and an interrupted center line. The light distribution is sketched in the high beam. The light distribution is represented by a set of isolux lines, which connects points of equal illumination intensity. Areas between the isolux lines are shaded in different grey tones. In addition, delineators 300 are drawn in at an estimated distance from one another of 50 m in each case. The provided approach is shown well by this sketch. Far removed delineators 300, as examples of reflecting objects, are able to be detected for the first time in the area of low illumination intensity 302. The vehicle now moves forward. For this reason, reflecting objects 300 apparently “move” with respect to the vehicle through the subsequent areas all the way to the area having maximally detectable illumination intensity 304, in order finally to be detected again in areas having low illumination intensity.

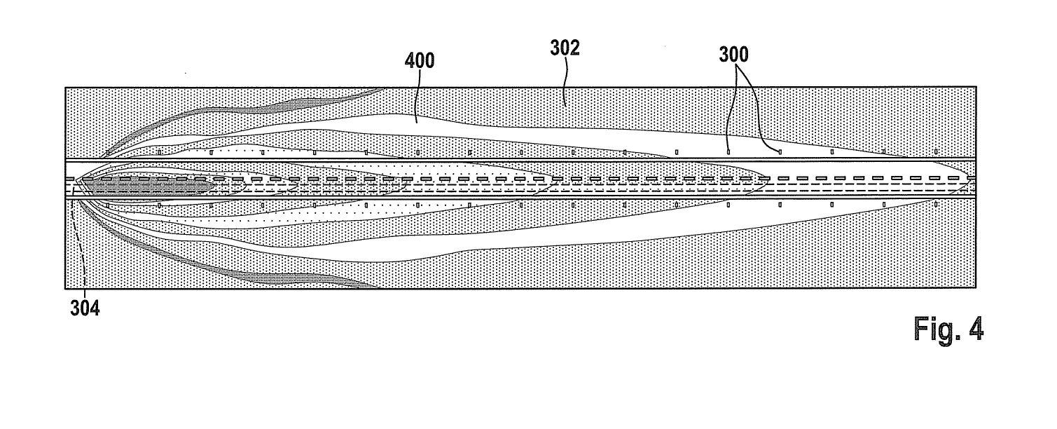

FIG. 4 shows a top view of the brightness distribution of FIG. 3. An assumed light distribution for xenon headlights is sketched in perspective, in high beam operation. Areas having approximately the same illumination intensity are shaded in the same grey tone. Area 302 corresponds, in this case, to an assumed illumination intensity of 1 lx, area 400 to 3 lx and area 304 to 110 lx.

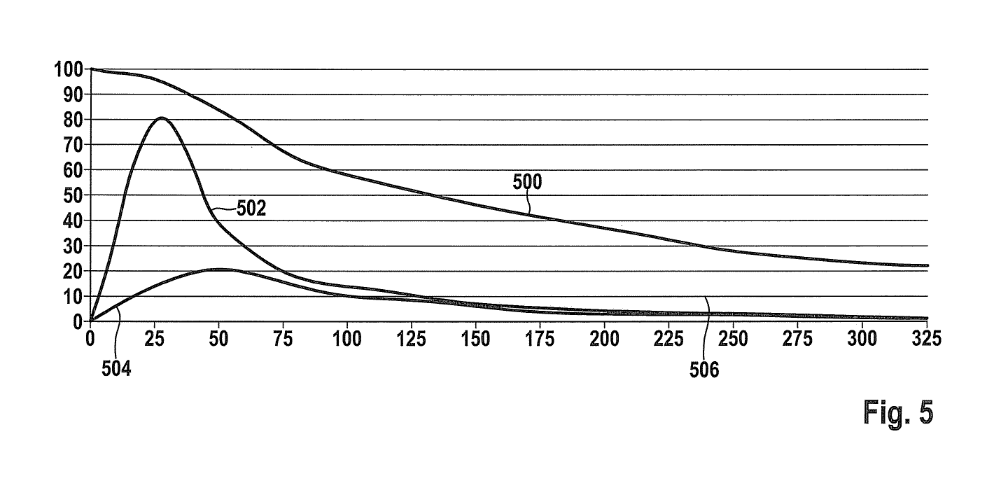

FIG. 5 shows a diagram of three characteristics curves of the brightness values to be expected according to an exemplary embodiment of the present invention. A curve “over time” is schematically sketched of three static objects as reference objects by the light distribution in FIGS. 3 and 4, while the vehicle moves forward. The distance of the vehicle in meters is plotted on the abscissa of the diagram. A perceptible illumination intensity in per cent is plotted on the ordinate. While characteristics curve 500 corresponds to the change in the measured (normalized) brightness of a self-illuminating object, characteristics curves 502 and 504 characterize the change in the brightness of a reflecting object having a lateral distance of 5 m (504) and 10 m (502) from the vehicle longitudinal axis. Line 506 in this case specifies the detection threshold, i.e., objects lying below this threshold 506 are not taken into account or classified. Characteristics curve 500 drops from 100% brightness at zero meters at a slightly changed slope down to a value of 20% at 325 m. Characteristics curve 502 rises steeply from the origin to a high point at 80% brightness at 25 meters and after that drops sharply again. At increasing distance, the characteristics curve at constantly flatter slope approaches zero per cent brightness at 325 meters. Characteristic curve 504 rises flatly from the origin to a high point at 20% at 50 meters, in order also to drop off asymptotically to zero per cent at 325 meters. While the change of various features of self-luminous objects, sketched in this case with the example of detectable brightness, behaves proportionally to the change in the distance (covered path of the vehicle), the feature itself is, on the one hand, detectable substantially later, and on the other hand, the change in the feature for reflecting objects is substantially more significant, i.e., the rise in relation to a reference variable, preferably the covered path, is substantially steeper up to a certain point.

After that, the distinction of the feature decreases continuously again, while, in contrast to self-luminous objects, the last-named relationship is not present. Thus, for example, the change of a detectable feature is either significantly greater than a previously specified threshold value or is correspondingly smaller.

The influence of, for example, dynamic cornering light or other possible light distributions on the predictable change of the features are able to be taken into account in making the distinction between self-luminous and reflecting objects correspondingly.

The exemplary embodiments described and shown in the figures have been selected only in exemplary fashion. Different exemplary embodiments are able to be fully combined with one another, or with regard to individual features. One exemplary embodiment may also be supplemented by features of another exemplary embodiment.

Furthermore, method steps according to the present invention may also be carried out repeatedly, as well as in a different sequence than the one described.

What is claimed is:

1. A method for distinguishing a self-luminous object from a reflecting object in a detection range of a camera of a vehicle having at least one headlight, if the object is illuminated by the headlight, the method comprising:
receiving a relative position of the object with respect to the vehicle and a brightness value of the object from the camera;
comparing the brightness value to at least one of (i) a self-luminous value expected at the relative position and (ii) a reflection value expected at the relative position; and
classifying the object as one of (i) self-luminous, if the brightness value is within a self-luminous tolerance range about the self-luminous value and (ii) reflecting, if the brightness value is within a reflection tolerance range about the reflection value.

2. The method according to claim 1, further comprising:
ascertaining at least one of (i) a function of self-luminosity values to be expected at different relative positions in front of the vehicle and (ii) a function of reflection values to be expected at different relative positions in front of the vehicle.

3. The method according to claim 1, wherein, during the receiving, in response to moving of the vehicle, an additional relative position of the object with respect to the vehicle and an additional brightness value of the object are received, and during the comparing, the additional brightness value is compared to at least one of (i) an additional self-luminosity value expected at the additional relative position and (ii) an additional reflection value expected at the additional relative position, and during the classifying, the object may further be classified as one of (i) self-luminous if the additional brightness value is located within an additional self-luminous tolerance range about the additional self-luminous value and (ii) reflecting if the additional brightness value is located within an additional reflection tolerance range about the additional reflection value.

4. The method according to claim 3, wherein, during the comparing, a gradient between the brightness value and the additional brightness value is compared to at least one of (i) a self-luminous gradient expected between the relative position and the additional relative position and (ii) a reflection gradient expected between the relative position and the additional relative position, and during the classifying, the object is further classified as one of (i) self-luminous if the gradient is located within a self-luminous gradient tolerance range about the self-luminous gradient, and (ii) reflecting, if the gradient is located within a reflection gradient tolerance range about the reflection gradient.

5. The method according to claim 1, wherein the classifying is not carried out if, during the comparing, the brightness value is detected as being less than a predetermined threshold value.

6. A device for distinguishing a self-luminous object from a reflecting object in a detection range of a camera of a vehicle having at least one headlight, if the object is illuminated by the headlight, the device comprising:
an apparatus configured for receiving a relative position of the object with respect to the vehicle and for receiving a brightness value of the object from the camera;
an apparatus configured for comparing the brightness value to at least one of (i) a self-luminous value expected at the relative position and (ii) a reflection value expected at the relative position; and
an apparatus configured for classifying the object as one of (i) self-luminous, if the brightness value is within a self-luminous tolerance range about the self-luminous value and (ii) reflecting, if the brightness value is within a reflection tolerance range about the reflection value.

7. A computer program product having program code stored on a non-transitory computer-readable medium, wherein the program code instructs a programmable computer system to perform the steps of the method according to claim 1.
